(19) United States
(12) Patent Application Publication
(10) Pub. No.: US 2007/0133471 A1
(43) Pub. Date: Jun. 14, 2007

(54) System for interworking services of heterogeneous networks and method for vertical handoff

(76) Inventors: Seung-Hee Kim, Daejeon-city (KR); Dae-Sik Kim, Daejeon-city (KR); Jin-Sung Cho, Seoul (KR); Du-Kyung Kong, Namnyangju-city (KR)

Correspondence Address: LADAS & PARRY LLP, 224 SOUTH MICHIGAN AVENUE, SUITE 1600, CHICAGO, IL, 60604, US

(21) Appl. No.: 11/607,419

(22) Filed: Dec. 1, 2006

(30) Foreign Application Priority Data
Dec. 2, 2005 (KR) 10-2005-0116951

(51) Int. Cl. H04Q 7/00; H04L 12/56

(52) U.S. Cl. 370/331; 370/395.21

(57) ABSTRACT

An interworking network system between heterogeneous networks and a vertical hand-off method for supporting QoS are provided. WLAN (Wireless Local Area Network) and Wibro (Wireless Broadband) have a service range overlaid with that of the CDMA (Code Division Multiple Access) 2000 that has been provided over the whole area, and routers of the respective networks are hierarchically connected by setting the CDMA 2000 as a higher network, the WiBro as a middle network, and the WLAN as a lower network according to service area and transmission speed of the respective networks. Accordingly, a hierarchical interworking method has been provided as an integrating network of the CDMA 2000, WiBro, and WLAN independently providing a service so that it may minimize packet loss and delay.

### BACKGROUND OF THE INVENTION

(a) Field of the Invention

The present invention relates to an interworking network system between heterogeneous networks and a vertical hand-off method for supporting a quality of service (hereafter referred to as “QoS”).

(b) Description of the Related Art

Generally, a mobile IP used in Internet protocol (hereinafter referred to as “IP”) starts from an IPv5-based format and has been further developed as an IPv6-based format because the IP resources that are capable of being allocated are limited, the number of users has increased, and provision of various services are desired. In addition, the mobile IP allocates IP addresses to respective terminals and facilitates communication between them using the allocated addresses. Such system is largely divided into two types. The first system is an MIPv6 format and the second system is a Hierarchical Mobile IPv6 (hereinafter referred to as “HMIPv6”) format.

FIG. 1 is a network configuration diagram for providing an interworking service of heterogeneous networks according to the prior art.

Referring to FIG. 1, CDMA2000, WiBro, and WLAN networks are coupled by the conventional mobile IP scheme, and an HA (Home Agent) is provided in the public network. The CDMA2000, WiBro, and WLAN networks are independently interworked. However, the service range thereof may be overlaid.

In FIG. 1, the circle indicates a service allowance area. The CDMA2000, WiBro, and WLAN networks are independently connected to the HA so as to link to each other. According to such an interworking structure, whenever the user terminal moves or requests new services, the user terminal performs a registration on the HA.

Such a structure may cause delay and packet loss on the vertical hand-off. Therefore, in such an interworking structure of networks, a new interworking structure and operating method thereof have been developed so as to minimize a packet loss and delay and to increase efficiency, and so as to guarantee sufficient QoS such that various services may be provided according to the user demand on the characteristics of the interworking structure.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an interworking network system having advantages of minimizing a packet loss by configuring heterogeneous networks including CDMA2000, WiBro, and WLAN as an overlay structure.

In addition, the present invention has been made in an effort to provide a vertical hand-off in such an interworking network system having advantages of reducing a delay due to network registration and selection processes upon vertical handoff and ensuring a sufficient QoS.

An exemplary embodiment of the present invention provides a vertical hand-off method of a user terminal in heterogeneous networks that are capable of cooperating by including a plurality of access routers, wherein the plurality of access routers include a serving access router on the network including the user terminal, and a plurality of candidate access routers hierarchically connected to the network. The vertical hand-off method includes:

(a) the serving access router selecting a target access router for hand-off based on a router request message received from the user terminal;

(b) achieving a connection between the target access router and the user terminal by the serving access router transmitting a router broadcasting message including the target access router information to the user terminal; and

(c) the target access router requesting binding update and QoS processing of the user terminal to a higher access router, and performing a hand-off according to a binding update message and a QoS option message transmitted from the user terminal.

Yet another embodiment of the present invention provides a heterogeneous network system for supporting a vertical hand-off of a user terminal. The heterogeneous network system includes heterogeneous networks, each of which includes a serving network having the user terminal and a plurality of candidate networks hierarchically connected to the serving network, that are hierarchically connected and that support the vertical hand-off, and a message receiver for receiving a router request message for the vertical hand-off from the user terminal; an access router determiner for determining a target access router among a plurality of candidate access routers included in the candidate networks based on the router request message received from the message receiver; and a message transmitter for transmitting a router broadcasting message including the target access router information to the user terminal.

### BRIEF DESCRIPTION OF THE DRAWINGS

FIG. 1 is a network configuration diagram of an interworking service of a heterogeneous network according to the prior art.

FIG. 2 is a network configuration diagram of an interworking service of a heterogeneous network according to an exemplary embodiment of the present invention.

FIG. 3 is a configuration diagram of a serving access router according to an exemplary embodiment of the present invention.

FIG. 4 is a flowchart showing a hand-off operation for supporting QoS on mobility between the heterogeneous networks according to an exemplary embodiment of the present invention.

FIG. 5 illustrates an Extended-RtSol message format according to an exemplary embodiment of the present invention.

FIG. 6 illustrates an Extended-RtAdv message format according to an exemplary embodiment of the present invention.

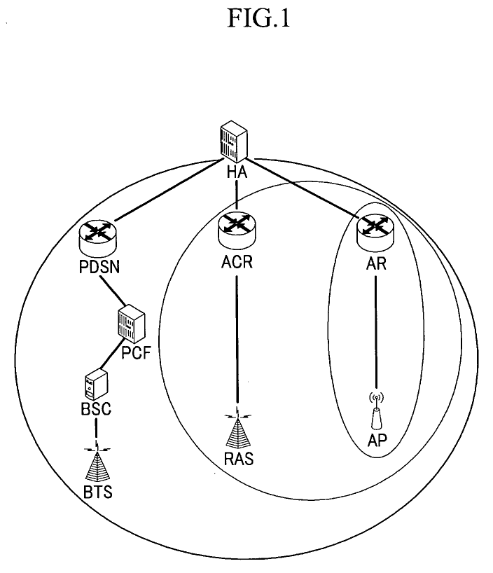

### DETAILED DESCRIPTION OF THE EMBODIMENTS

An exemplary embodiment of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

When it is described that an element is coupled to another element, the element may be directly coupled to the other element or coupled to the other element through a third element.

According to the activation of WiBro, the CDMA2000 and WLAN have developed so as to construct an interworking structure using the WiBro and provide various services. In addition, the users desire high-speed Internet packet service and multimedia service as well as a voice service. However, various conditions are desired so as to construct an interworking network because the CDMA2000 and WLAN, excluding the WiBro, have been used according to independent standards. Accordingly, such various conditions include an All-IP-based network structure for integrating all of voice, image, and data into IP, and processing the integrated data, mobility, and QoS.

Each network has a hierarchical structure and they organically cooperate with each other. That is, an ACR (Access Control Router, or candidate access router) of the WiBro may be coupled to a PDSN (Packet Data Serving Node, or serving access router) of the CDMA2000 network (or serving network), and an AR (Access Router, or candidate access router) of the WLAN (or candidate network) may be coupled to the ACR of the WiBro network (or candidate network). In addition, networks form an overlay structure in the interworking service so that consecutive service may be provided. Such a hierarchical interworking structure uses a new message format for obtaining information of networks to be moved and for ensuring a desired QoS, as well as an extended hierarchical MIPv6 (Hierarchical Mobile Internet Protocol v6) for providing mobility.

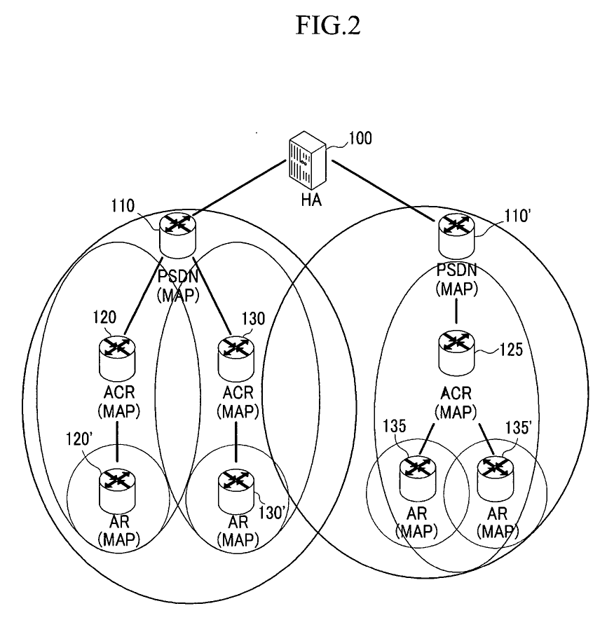

A network structure for providing such a service will be described with reference to FIG. 2. In this embodiment, an IPv6 based system is used as one exemplary embodiment.

FIG. 2 is a network configuration diagram of an interworking service of a heterogeneous network according to an exemplary embodiment of the present invention. Referring FIG. 2, a network structure for interworking a heterogeneous network includes an HA 100, PDSNs 110 and 110′, ACRs 120, 120′, and 125, and ARs 130, 130′, 135, and 135′.

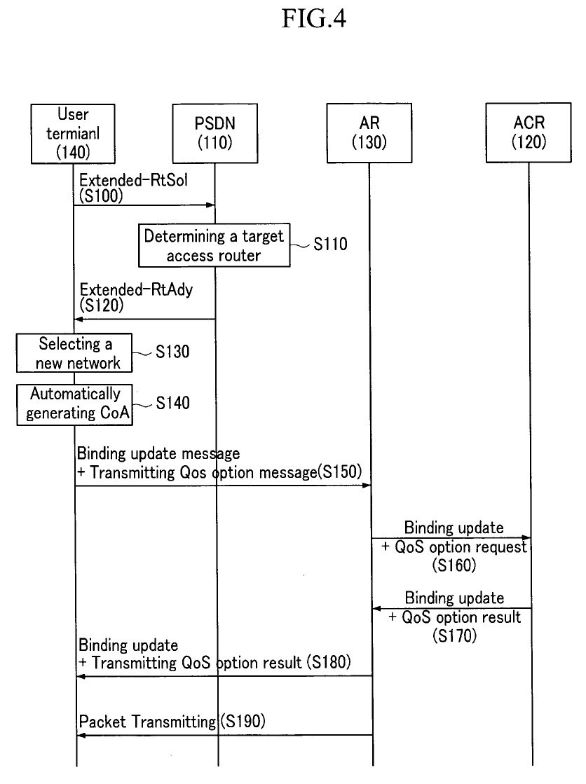

The HA 100 is provided in a home network of mobile nodes, and is a router for maintaining location information of a user terminal 140 (see FIG. 4) and for transmitting data to a user terminal mobile connected to external networks. That is, the HA 100 is provided with all information of the user terminal. In addition, the location information of the user terminal and currently-used IP address information are stored together therein.

The PDSNs 110 and 110′ provide a mobility management function for users of the user terminal that are interworked with the HA 100 and are occasionally moved, and provide such operations as the user terminal may desire with Internet data service without changing the IP address thereof. Such functions are also performed in the ACRs 120, 120′, and 125 of the WiBro and the ARs 130, 130′, 135, and 135′s of the WLAN. Herein, the PDSNs 110 and 110′ are provided among the ACRs 120, 120′, and 125 of the WiBro, which sets the HA 100 and the PDSNs 110 and 110′ as an upper network. The ACRs 120, 120′, and 125 are provided among the ARs 130, 130′, 135, and 135′s of the WLAN, which sets the PDSNs 110 and 110′ and ACRs 120, 120′, and 125 as an upper network.

The PDSNs 110 and 110′, the ACR 120, 120′, and 125, and the ARs 130, 130′, 135, and 135′ are upper MAPs (Mobility Anchor Point) for managing local mobility in the case that the mobility of the user terminal may occur between networks by the idea of the hierarchical MIPv6. When the user terminal moves between networks or requests service changing, it can minimize a delay and packet loss due to the registration process of the user terminal because the registration process is performed on the PDSNs 110 and 110′, the ACRs 120, 120′, and 125, or the ARs 130, 130′, 135, and 135′ without a direct registration process on the HA 100 as in the prior art. The MAP may nationally operate as a local home agent, minimize a changing of the MIPv6, and enhance a performance thereof. That is, the hierarchical interworking structure is more appropriate for a real-time service such as a VoIP (Voice over Internet Protocol) than an independent plane interworking structure.

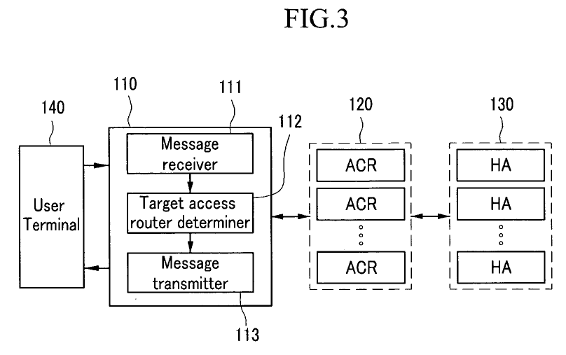

FIG. 3 is a configuration diagram of a serving access router according to an exemplary embodiment of the present invention.

Referring to FIG. 3, the serving access router includes a message receiver 111, a target access router determiner 112, and a message transmitter 113.

According to an exemplary embodiment of the present invention, the serving access router shown in FIG. 3 corresponds to the PDSN 110, the message receiver 111 receives the extended router request message from the user terminal 140, the target access router determiner 112 determines a target access router that is capable of performing a handover among a plurality of target access routers (in this embodiment, the ACRs 120, 120′, and 125 and the HAs 130, 130′, 135, and 135′ are included) based on information in the message.

When the target access router is determined, the message transmitter 113 transmits it through the extended router broadcasting message to the user terminal 140.

In case that the user terminal moves between the networks having such elements, a delay due to the mobility may be minimized, speedy service may be ensured, and the QoS may be supported on the interworking structure. At this time, a hand-off method for supporting QoS when the hand-off occurs from the CDMA2000 network to the WLAN network will be described with reference to FIG. 4.

FIG. 4 is a flowchart showing a hand-off operation for supporting QoS on mobility between the heterogeneous networks according to an exemplary embodiment of the present invention. As shown in FIG. 4, operation processes for supporting QoS and performing a hand-off uses the extended hierarchical MIPv6 so as to provide mobility, and uses a message according to an exemplary embodiment of the present invention for the determination information and QoS of the target network. At this time, the hand-off between the networks interworked hierarchically is referred to as a vertical hand-off.

First, the user terminal transmits an Extended-RtSol (Extended Router Solicitation, or extended router request) message to the PDSN 110 of the currently connecting CDMA2000 (S100). The Extended-RtSol message is provided and extended from the RtSol message of the HMIPv6 such that the QoS information may be obtained. The Extended-RtSol message will be described with reference to FIG. 5. The Extended-RtSol message transmitted to the PDSN 110 includes basic conditions that the user terminal requests on the hand-off between the networks, network interfaces, QoS, and service cost information.

The PDSN 110 receives the Extended-RtSol message corresponding to a most upper MAP on the hierarchical structure, supports mobility to the user terminal, periodically updates the lower level of the WiBro and the ARs 130, 130′, 135, and 135′ information of the WLAN, and maintains new information so as to provide periphery PDSN 110′ information and various services. Accordingly, the PDSN 110 having received the Extended-RtSol message firstly performs pre-filtering of the conditions of the user terminal so that it determines the target ACRs 120, 120′, and 125 or the ARs 130, 130′, 135, and 135′. The pre-filtering is a method for changing the given query and searching the same using a user profile when the user inputs a query.

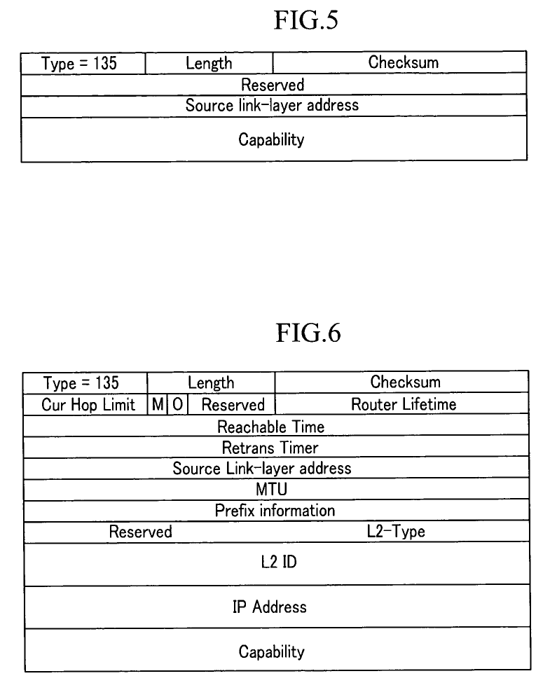

The PDSN 110 determines the target access router through the collected information by the pre-filtering (S110), and transmits the corresponding information included in the extended router broadcasting (Extended Router Advertisement, hereinafter referred to as “Extended-RtAdv”) message to the user terminal (S120). The Extended-RtAdv message is newly provided and extended from the RtAdv message structure of the HMIPv6 so as to obtain the QoS information. The Extended-RtAdv message format will be described with reference to FIG. 6.

The user terminal 140 receiving the Extended-RtAdv message selects a new network according to the information in the message (S130). In this embodiment, the user terminal 140 selects the AR 130 of the WLAN. The user terminal 140 automatically generates a new CoA (Care of Address or mobility address) by setting a link to the WLAN which is a new network (S140).

After the user terminal 140 sets the link to the AR of WLAN of the new network WLAN AR 130, the user terminal 140 transmits a QoS Option message along with a BU (Binding Update) message to the AR 130 (S150). The QoS Option message uses a Hop-by-Hop option of the BU message. The BU message includes a source address, a destination address, and a home address of the user terminal.

The Hop-by-Hop header includes IP options for all systems on the routers of the datagram. All the routers on the path search and process the Hop-by-Hop option header. Generally, each option of the header is formed with a format, a length, and a value. The format and length respectively have a size of bite. The format indicates a designed option and the length indicates the number of bites in the option values. The Hop-By-Hop option includes options to be processed every passing hop. Accordingly, the Hop-By-Hop option includes all of registration information and QoS information on which the requested QoS is satisfied for the user terminal 140.

After the AR 130 processes a binding and QoS of the user terminal 140, the AR 130 transmits the QoS Option message along with the BU message and with the upper MAP (S160). The upper MAP is given as the ACR 120 because the ACR 120 is provided on the present access router according to the hierarchical structure. The upper MAP, the ACR 120 transmits a BA (Binding Acknowledge) message and QoS Result message as a process result of the BU message and QoS to the AR 130 (S170).

The AR having received the message from the ACR 120 transmits the BA message and QoS result message to the user terminal 140 (S180). The user terminal having received the BA message performs a communication to the corresponding AR 130 because the connections between the AR 130 and L2/L3 (Layer 2/Layer 3) are wholly finished. When the connections between the AR 130 and L2/L3 (Layer 2/Layer 3) are wholly finished, the AR 130 transmits packets that are buffered in the PDSN 110 during the hand-off to the terminal 140 (S190).

In such a flowchart, a disconnect with the previous network PDSN 110 may be performed between the step S140 for automatically generating the new CoA through setting a link to the new network and the step S150 for transmitting the BU message and QoS Option message to the ACR 130 (Break-Before-Make), and between the steps S180 and S190 (Make-Before-Break). In addition, in order to reduce resetting processes due to a user service complaint, a new network is selected through traffic information as the basic QoS information transmitted by the Extended-RtSol message and Extended-RtAdv message traffic (Traffic) information and the QoS information is obtained through the step S150, in which the sufficient QoS is satisfied.

This is proposed so as to enhance service efficiency and prevent roll-back of hand-off, which occurs when the service does not satisfy QoS, by considering QoS parameters on the selecting of the target AR of hand-off.

FIG. 5 illustrates an Extended-RtSol message format according to an exemplary embodiment of the present invention.

The Extended-RtSol message is provided from the RtSol message of the HMIPv6. The RtSol message is transmitted from an IPv6 host so as to search the interworking IPv6 router, and the host transmits a directly responding message to the IPv6 router as a multicast router request without waiting for the periodic router message.

The Extended-RtSol message is newly provided and extended from the RtSol message such that the QoS information may be obtained. Referring to FIG. 5, information for determining a network that is capable of satisfying the user requirements by including user requirements to the service as well as basically informing the start of hand-off of the user terminal 140 and information of the corresponding network are included.

Referring to the message format field, a “Type” field is indicated as 135 so as to inform the Extended-RtSol message of the PDSN 110, but is not limited thereto. A “Capability” field corresponding to a first characteristic indicates capability information that the user terminal 140 requests for the network.

The “Capability” field includes basic QoS elements as desired service conditions, that is, an Average Data Rate, Burstiness (Token Bucket Size), Peak Data Rate, Minimum Policed Unit, and Maximum Packet Size information inserted therein. In addition, the “Capability” field includes an Average Cost field inserted therein considering service cost as well as services on the overlay network.

Other RtSol message fields on the conventional protocol are not described because they are obvious to a person of ordinary skill in the art.

FIG. 6 illustrates an Extended-RtAdv message format according to an exemplary embodiment of the present invention.

The Extended-RtAdv message is extended from the RtAdv message and is newly provided such that the QoS information may be obtained. The Extended-RtAdv message is periodically transmitted from the access router, and is transmitted to the user terminal 140 as a response of the Extended-RtSol. In addition, information for determining a network that is capable of satisfying the user requirements by including user requirements to the service as well as basically informing the address information of the corresponding AR are included.

Referring to a message format field, the “Type” field, indicated as 136, represents the Extended-RtAdv message, but is not limited thereto. The “L2-Type” field indicates an interface type of the target ARs. The “L2-ID” field indicates a variable length L2 identifier of the target ARs.

The “IP Address” field indicates a list of variable length IP addresses of the target ARs, which is matched with the L2 ID field. The “Capability” filed corresponding to the second characteristic indicates capability information that the network can provide. That is, the “Capability” field means a capability that the network including the user terminal 140 can provide to the user terminal 140.

As service requirements that the user requires, basic QoS elements, that is, Average Data Rate, Burstiness (Token Bucket Size), Peak Data Rate, Minimum Policed Unit, and Maximum Packet Size information are inserted in the “Capability” field, and an Average Cost field is inserted considering service cost as well as the service on the overlay network. Other fields not noted above are not described in detail because they are the same as the RtAdv message fields of the conventional protocol.

The message shown in FIG. 5 and FIG. 6 may obtain a Link-Layer address and an IP address of the access router that the user terminal 140 needs to be moved on the overlay network, and provide various services on the overlay network structure. Accordingly, the messages may obtain the QoS parameter that is basically necessary for the QoS that the user terminal 40 requires and the cost parameter information considering a service cost. The user terminal 140 may select the most appropriate AR in such message information based on the hierarchical interworking structure.

The above-described methods and apparatuses are not only realized by the exemplary embodiment of the present invention, but, on the contrary, are intended to be realized by a program for realizing functions corresponding to the configuration of the exemplary embodiment of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to an exemplary embodiment, a hierarchical interworking scheme is proposed as an integrated network that is divided into CDMA2000, WiBro, and WLAN independently providing a service, so that packet loss and delay may be minimized and various future services may be provided.

In addition, the hierarchical MIPv6 can ensure mobility and QoS.

Further, the user can consider the QoS and service cost because of obtaining the service cost information as well as the QoS information.

What is claimed is:

1. A vertical hand-off method of a user terminal in heterogeneous networks that are capable of cooperating by including a plurality of access routers,
wherein the plurality of access routers include a serving access router on a network including a user terminal and a plurality of candidate access routers hierarchically connected to the network and that are hierarchically connected, the vertical hand-off method comprising:
(a) the serving access router selecting a target access router for hand-off based on a router request message received from the user terminal;
(b) achieving a connection between the target access router and the user terminal by transmitting a router broadcasting message including the target access router information to the user terminal the serving access router; and
(c) the target access router requesting binding update and QoS processing on the user terminal from a higher access router, and performing a hand-off according to a binding update message and a QoS option message transmitted from the user terminal.

2. The vertical hand-off method of claim 1, wherein the step (c) comprises:
(i) a higher access router receiving the binding update and QoS process request through which the target access router performs a binding update process and a QoS process;
(ii) transmitting a processed result to the target access router when the binding update process and the QoS process are finished; and
(iii) the target access router transmitting a packet to the user terminal according to the processed result for the binding update and QoS process request of the higher access router.

3. The vertical hand-off method of claim 1, wherein the step (b) includes:
(i) the user terminal generating a CoA (Care of Address) for the network including the target access router;
(ii) the user terminal performing a connection to the generated CoA; and
(iii) performing a disconnection between the network including the serving access router and the user terminal.

4. The vertical hand-off method of claim 3, wherein the disconnection between the network and the user terminal is performed after the user terminal receives the processed result for the binding update and QoS process request of the step (c).

5. The vertical hand-off method of claim 1, wherein the higher access router is a higher mobility anchor point of the target access router.

6. A heterogeneous network system for supporting a vertical hand-off of a user terminal, the heterogeneous network system comprising:
the heterogeneous network, including a serving network having the user terminal and a plurality of candidate networks hierarchically connected to the serving network, being hierarchically connected and supporting the vertical hand-off;
a message receiver for receiving a router request message for the vertical hand-off from the user terminal;
an access router determiner for determining a target access router among a plurality of candidate access routers included in the candidate networks based on the router request message received from the message receiver; and
a message transmitter for transmitting a router broadcasting message including the target access router information to the user terminal.

7. The heterogeneous network system of claim 6, wherein the target access router processes the binding update message and QoS option message transmitted from the user terminal in the case of a vertical hand-off by the user terminal.

8. The heterogeneous network system of claim 7, wherein the target access router is a router included in the hand-off destination network of the user terminal and it receives the binding update message and QoS option message process result.

9. The heterogeneous network system of claim 6, wherein the router request message includes a type field for indicating a router request message and a first characteristic (Capability) field which the user terminal requests from the network including the user terminal, the first characteristic including a data rate, a maximum packet size, and a minimum policy unit.

10. The heterogeneous network system of claim 6, wherein the router broadcasting message includes a type (Type) field for indicating a router broadcasting message, an IP address (IP Address) field for indicating a list of IP addresses of the target access routers for the hand-off in the heterogeneous network, and a second characteristic (Capability) field for indicating a characteristic that the network including the user terminal can provide to the user terminal), the second characteristic including an average data rate, a token bucket size, a peak data rate, a minimum policy unit (Policy Unit), and a maximum packet size.
